(19) United States
(12) Patent Application Publication
(10) Pub. No.: US 2025/0015887 A1
(43) Pub. Date: Jan. 9, 2025

(54) MONITORING IN DISTRIBUTED ACOUSTIC SENSING SYSTEMS

(71) Applicant: SUBCOM, LLC, Eatontown, NJ (US)

(72) Inventors: William W. PATTERSON, Freehold, NJ (US); Jin-Xing CAI, Morganville, NJ (US); Carl R. DAVIDSON, Warren, NJ (US); Alexei N. PILIPETSKII, Long Branch, NJ (US); Georg Heinrich MOHS, East Brunswick, NJ (US)

(73) Assignee: SUBCOM, LLC, Eatontown, NJ (US)

(21) Appl. No.: 18/762,038

(22) Filed: Jul. 2, 2024

Related U.S. Application Data
(60) Provisional application No. 63/525,068, filed on Jul. 5, 2023.

(51) Int. Cl. H04B 10/079

(52) U.S. Cl. CPC H04B 10/0795

(57) ABSTRACT

A method and a system for monitoring an optical transmission path in an optical transmission system. A signal is transmitted on a portion of the optical transmission path. The optical transmission path includes a plurality of portions. A clock synchronization signal in a plurality of clock synchronization signals is assigned to the transmitted signal. A backscattered signal is received. The backscattered signal is generated by the portion of the optical transmission path in response to the signal being transmitted on the portion of the optical transmission path. Based on the assigned clock synchronization signal, the portion of the optical transmission path is monitored by analyzing the backscattered signal to determine a presence of an interference on the portion of the optical transmission path.

### CROSS-REFERENCE TO RELATED APPLICATIONS

The present application claims the benefit of and priority under 35 U.S.C. § 119 to U.S. Provisional Patent Application No. 63/525,068 to Patterson et al., filed Jul. 5, 2023, and entitled “Monitoring in Distributed Acoustic Sensing Systems,” and incorporates its disclosure herein by reference in its entirety.

### TECHNICAL FIELD

This disclosure relates generally to optical communication systems, and in particular, to distributed acoustic sensing, and in particular, to the elimination of interrogation pulse distortion in distributed acoustic sensing systems by, for example, locating distributed acoustic sensing transmitters in repeater housings.

### BACKGROUND

In a distributed acoustic sensing (DAS) system, an optical cable may be used to provide real-time or near real-time distributed strain sensing. In other words, the cable itself may be used as a sensing element to detect or monitor different types of disruptions, interferences, irregularities, activities, whether man-made or naturally occurring events, acoustic vibrations, etc. in the DAS environment (e.g., terrestrial environment, undersea environment). To do so, an optoelectronic device coupled to the optical cable of the DAS system may detect and process reflected light signals (e.g., acoustic frequency strain signals) over a specific distance in the DAS environment.

For example, the DAS system may be based on Rayleigh backscattering (otherwise referred to as a Rayleigh-scattering-based DAS system). In this system, a coherent laser pulse may be sent along an optical fiber, and scattering sites within the optical fiber may cause the fiber to act as a distributed interferometer, e.g., with a gauge length approximately equal to the pulse length. The intensity of any reflected light may be measured as a function of time after transmission of the laser pulse, which is known as Coherent Optical Time Domain Reflectometry (COTDR).

In some existing systems, telecommunications optical fiber is used as a distributed sensor to detect spatial disturbances contiguously along the transmission/sensing fiber over long distances in real time. However, conventional sensing systems are limited to single short fiber lengths that fail to provide assessment of the entire length of the fiber. Moreover, sensing in such systems is further limited by the maximum peak power of interrogation pulses that may be transmitted on the fiber. Additionally, indirect connection of DAS transmitters generating the interrogation pulse causes substantial distortions in sensing responses to the transmitted pulses, thereby significantly impairing measurement sensitivity.

### SUMMARY

In some implementations, the current subject matter relates to a method for monitoring an optical transmission path in an optical transmission system. The method may include transmitting a signal on a portion of the optical transmission path, where the optical transmission path may include a plurality of portions, and each portion in the plurality of portions may include a termination point. The method may further include assigning a clock synchronization signal in a plurality of clock synchronization signals to the transmitted signal, and receiving a backscattered signal. The backscattered signal may be generated by the portion of the optical transmission path in response to the signal being transmitted on the portion of the optical transmission path. The method may also include monitoring, based on the assigned clock synchronization signal, the portion of the optical transmission path by analyzing the backscattered signal to determine the presence of an interference on the portion of the optical transmission path.

In some implementations, the current subject matter may include one or more of the following optional features. The optical transmission path may be a distributed acoustic sensing optical transmission path. The optical transmission system may include a plurality of terminals communicatively coupled to at least one transmitting path for transmitting and at least one receiving path for receiving one or more signals between at least two terminals in the plurality of terminals. Transmission of the signal may include transmitting the signal from a transmitting optical device communicatively coupled to the portion of the optical transmission path.

In some implementations, a plurality of transmitting optical devices may be communicatively coupled to optical transmission path. Each transmitting optical device in the plurality of transmitting optical devices may be communicatively coupled to a respective portion in the plurality of portions of the optical transmission path without being communicatively coupled to another portion in the plurality of portions of the optical transmission path. A receiving optical device may be communicatively coupled to the optical transmission path and may be configured to receive a plurality of backscattered signals generated by each portion in the plurality of portions of the optical transmission path in response to a respective signal transmitted by the corresponding transmitting optical device in the plurality of transmitting optical devices. At least one optical repeater device may be communicatively coupled to the optical transmitting path.

In some implementations, the optical repeater device may include at least one transmitting optical device in the plurality of optical transmitting devices and may be associated with at least one portion in the plurality of portions of the optical transmission path. The optical repeater device may include at least one receiving amplifier and at least one transmitting amplifier. The receiving amplifier may amplify a signal transmitted on the receiving path. The transmitting amplifier may amplify a signal transmitted on the transmitting path. The receiving amplifier may amplify at least one backscattered signal generated by at least one portion of the optical transmitting path communicatively coupled to at least one optical repeater device in response to at least one signal transmitted by at least one transmitting optical device of the optical repeater device. The optical repeater device may be communicatively coupled to the receiving optical device.

In some implementations, at least one first optical device may be communicatively coupled to and between the optical repeater device and the receiving optical device. The receiving optical device may be configured to separate at least one backscattered signal for transmission to the receiving optical device and at least one signal transmitted on the receiving path for transmission to at least one terminal in the plurality of terminals.

In some implementations, the transmitting may include generating the clock synchronization signal simultaneously with transmitting the signal. The receiving of the backscattered signal may include associating the backscattered signal with the generated clock synchronization signal based on a time of generation of the clock synchronization signal.

In some implementations, the signal may be an interrogation signal.

In some implementations, at least one of: at least one portion in the plurality of portions of the optical transmission path and at least one termination point may be located at and/or in at least one of: a land location, a subsea location, and any combination thereof.

In some implementations, the current subject matter relates to a system for monitoring an optical transmission path in an optical transmission system. The system may include at least one transmitting optical device configured to transmit a signal on a portion of the optical transmission path. The optical transmission path may include a plurality of portions, where each portion in the plurality of portions may include a termination point. The system may also include at least one clock configured to assign a clock synchronization signal in a plurality of clock synchronization signals to the transmitted signal, at least one receiving device configured to receive a backscattered signal being generated by the portion of the optical transmission path in response to the signal being transmitted on the portion of the optical transmission path, and at least one processor configured to monitor, based on the assigned clock synchronization signal, the portion of the optical transmission path by analyzing the backscattered signal to determine the presence of an interference on the portion of the optical transmission path.

In some implementations, the system may also include one or more of the above optional features, as discussed herein.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary optical communication system;

FIG. 2 illustrates another exemplary optical communication system that may implement the distributed acoustic sensing techniques;

FIG. 3 illustrates an exemplary optical communication system using distributed acoustic sensing, according to some implementations of the current subject matter;

FIG. 4 illustrates an example process 400 for monitoring an optical transmission path in an optical transmission system, according to some implementations of the current subject matter; and

FIG. 5 illustrates an example processing system, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide an ability to eliminate interrogation pulse distortion in distributed acoustic sensing systems by, for example, locating distributed acoustic sensing transmitters in repeater housings.

In some implementations, the current subject matter relates to monitoring an optical transmission path (e.g., a DAS optical path) in an optical transmission system. The transmission system may include various communications components that may be deployed in any combination of terrestrial and/or subsea locations. The components may include optical transmitters and optical receiver communicatively coupled to a DAS optical path, a clock communicatively coupled to the transmitters and the receiver, a plurality of telecommunication terminals connected to one or more telecommunications optical paths, as well as one or more repeaters, some of which may include a transmitter. To perform such monitoring, an interrogation signal may be transmitted on a portion or a sensing span of the optical transmission path. The optical transmission path may include a plurality of such portions and/or sensing spans. Each such sensing span may be deployed between one or more transmitters, where at least one transmitter may be located in one or more repeaters, and may include a termination point. The interrogation signal may be transmitted using one or more transmitters. Upon transmission of the interrogation signal, the clock may assign a clock synchronization signal to the transmitted signal. The sensing span, upon receiving the interrogation signal may respond with a backscattered signal. The backscattered signal may be received by the receiver for analysis. The backscattered signal may be transmitted either directly to the receiver and/or indirectly, via one or more repeaters, to the receiver. The backscattered signal may be analyzed to determine the presence of any interferences, interruptions, faults, etc. in the sensing span of the DAS optical path.

In a distributed acoustic sensing (DAS) system, a DAS signal (e.g., light signal) may be transmitted by a DAS device (e.g., DAS interrogator) from an outbound optical cable. This DAS signal may be referred to as a transmit DAS signal. The transmit DAS signal may propagate along a first optical fiber of a bidirectional, dedicated and/or any other fiber pair of the optical cable in a first direction and may be periodically amplified by one or more optical amplifiers spaced along the fiber.

In some cases, the DAS system may provide subsea and/or undersea optical cable for extending DAS range. For example, DAS range may be extended by transmitting and/or amplifying a DAS signal along multiple spans of a first optical fiber, routing and/or bypassing the DAS signal from the first optical fiber to a second optical fiber that may be different from the first fiber via, for example, a high-loss loopback architecture, and returning and/or amplifying the DAS signal along the same multiple spans back to a DAS device. The DAS device may then receive and process the DAS signal to detect and/or determine any changes in the DAS system environment. Moreover, at a predefined distance along the optical cable (e.g., after the “Nth” amplifier along the optical cable), the transmit DAS signal may be returned to the DAS device by routing and/or bypassing the DAS signal to a second optical fiber of the fiber pair of the optical cable using, for example, the high-loss loopback architecture.

Moreover, a DAS signal may be routed and/or bypassed from the first optical fiber to the second optical fiber of the fiber pair based using different loopback architectures. In one example, the routing and/or bypass may be based on an output-to-output loopback architecture in which a first end of a loopback fiber is coupled to an output of an amplifier of the first optical fiber and a second opposed end of the loopback fiber is coupled to an output of an amplifier of the second optical fiber. In another example, the routing and/or bypass may be based on an output-to-input loopback architecture in which a first end of a loopback fiber is coupled to an output of an amplifier of the first optical fiber and a second opposed end of the loopback fiber is coupled to an input of an amplifier of the second optical fiber.

Accordingly, broader coverage provided by the extended DAS range allows a DAS system to better monitor subsea related activities. For example, the optical cables of the extended DAS system may be used to detect (“hear”) and/or monitor earthquakes, sea floor movement, ship signatures, passing of ships, dropping of anchors, dragging of fishing nets, etc. As such, the optical cables may effectively act as microphones to monitor potential issues and/or problems that may occur subsea/undersea, such as, for example, aggressions and/or potential aggressions to optical cables of a subsea optical communication system.

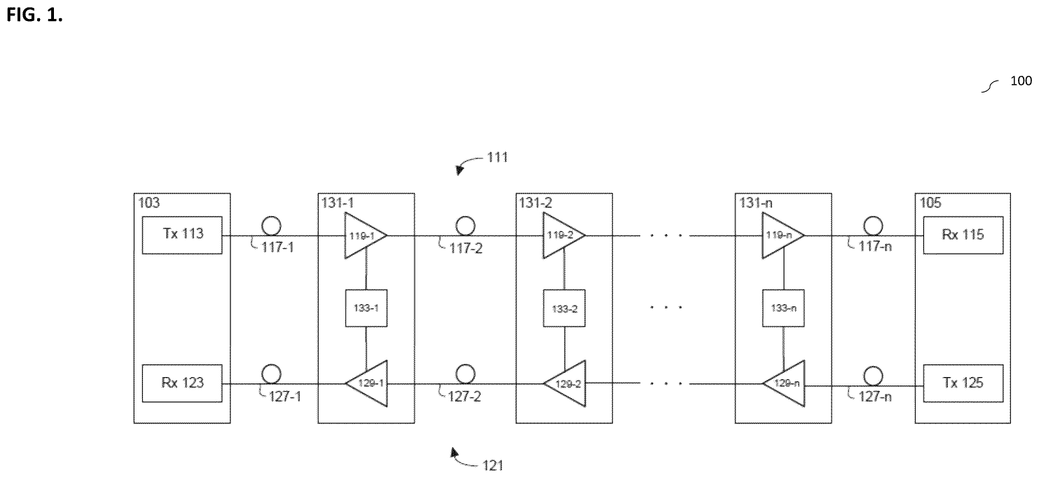

FIG. 1 illustrates an exemplary optical communication system 100. The system 100 may use high-bandwidth fiber optics to transmit/receive vast amounts of data over long distances. The bidirectional optical communication system 100 may also be referred to as a long-haul optical communication system. Bidirectional data transmission may be implemented by constructing pairs of optical fibers within an optical cable and/or transmitting one or more channels, e.g., wavelength division multiplexed channels, per fiber pair.

The system 100 may include terminals 103 and 105 communicatively coupled using (e.g., unidirectional) optical paths 111, 121. The terminal 103 may include a transmitter 113 and a receiver 123. Likewise, the terminal 105 may include a receiver 115 and a transmitter 125. The transmitter 113 of the terminal 103 may be communicatively coupled to the receiver 115 of the terminal 105 via the path 111. The transmitter 125 of the terminal 105 may be communicatively coupled to the receiver 123 of the terminal 103 via the communication path 121. The paths 111, 121 may form a bidirectional optical fiber pair. For example, the optical path 111 may transmit signal(s), data, information, etc. and/or any combination thereof in one direction, e.g., from the transmitter 113 to the receiver 115. Optical path 121 may transmit signal(s), data, information, etc. and/or any combination thereof in another direction, e.g., from the transmitter 125 to the receiver 123.

Thus, with respect to the terminal 103, the optical path 111 may be referred to as an outbound path and the optical path 121 may be referred to as an inbound path. The optical path 111 may include one or more optical fibers 117-1 to 117-n and one or more optical amplifiers 119-1 to 119-n, the latter being positioned within respective repeaters 131-1 to 131-n. Similarly, the optical path 121 may include one or more optical fibers 127-1 to 127-n and one or more optical amplifiers 129-1 to 129-n, the latter being positioned within the respective repeaters 131-1 to 131-n. The optical fibers 117-1 to 117-n and 127-1 to 127-2 may be individual segments of a single optical fiber 117 and/or a single optical fiber 127, respectively, where the segments may be formed by way of coupling of the amplifiers to the optical fibers 117 and 127, as shown in FIG. 1.

For example, one or more optical amplifiers 119-1 to 119-n and/or 129-1 to 129-n may be Erbium-doped fiber amplifiers (EDFAs), and/or any other optical amplifiers. Further, while transmitters 113, 115 and receivers 123, 125 are shown as separate components, as can be understood, transmitter 113 and/or receiver 123 may be housed together in a single housing and may form a transponder and/or transceiver at the terminal 103. Similarly, transmitter 115 and receiver 125 may also be housed together in a single housing and may form a transponder and/or transceiver at terminal 105.

As stated above, the optical path pair (e.g., optical paths 111, 121) may be configured as a set of amplifier pairs 119-1 to 119-n and 129-1 to 129-n within repeaters 131-1 to 131-n communicatively coupled thereto using pairs of optical fibers 117 (e.g., using optical fibers 117-1 to 117-n) and 127 (e.g., using optical fibers 127-1 to 127-n), which may be included in an optical fiber cable together with other fibers and/or fiber pairs supporting additional path pairs. As discussed above and shown in FIG. 1, for example, each repeater 131-1 to 131-n may include at least a pair of respective amplifiers 119-1 to 119-n, 129-1 to 129-n for each path pair and/or may include additional amplifiers for additional path pairs. As shown in FIG. 1, for example, the repeater 131-1 may include amplifiers 119-1 and 129-1.

The optical amplifiers 119-1 to 119-n, 129-1 to 129-n may include EDFAs and/or other rare earth doped fiber amplifiers, e.g., Raman amplifiers, semiconductor optical amplifiers (SOAs). Each repeater 131-1 to 131-n may also include respective coupling paths 133-1 to 133-n that may be communicatively coupled between optical paths 111, 121. It may be understood that the term “couple” and/or “coupled” and/or “communicatively coupled”, as used herein, may broadly refer to any connection, connecting, coupling, link, and/or linking, direct and/or indirect and/or wired and/or wireless connection, etc. but does not necessarily imply that the coupled components and/or elements are directly connected to each other.

It may be understood that the first and second optical fibers providing the transmit and return paths, respectively, may be included in and/or in form a bidirectional optical fiber pair. The fiber pair may be a standalone DAS-dedicated fiber pair. Alternatively, or in addition, it may be a payload carrying fiber pair, whereby the DAS signal may have a wavelength outside the payload channel wavelengths so that the DAS signal does not interfere with the payload signals. As can be understood, every “Nth” opposing set of amplifiers (e.g., the Nth amplifier coupled to the first optical fiber and the Nth amplifier coupled to the second optical fiber) may be paired and/or housed in the same respective repeater 131-1 to 131-n.

Using telecom optical fiber as a distributed sensor to achieve distributed acoustic sensing (DAS) has been used to detect spatial disturbances contiguously along the transmission/sensing fiber over long distances in real time. However, to date, distributed sensing has been limited to single fiber spans with lengths up 150 km. The maximum peak power of the interrogation pulse, in conventional systems, that can be launched into a sensing span is limited to about 23 dBm due to fiber nonlinearities. If the sensing span is directly connected to the DAS interrogator, then the DAS transmitter can directly apply the interrogation pulse. However, if the span to be sensed is not directly connected to the DAS transmitter, distortion can occur when transmitting the interrogation pulse to the span to be sensed, thus impairing the measurement sensitivity.

In that regard, in some implementations, the current subject matter relates to a distributed acoustic sensing system that may be configured to sense a span that may be deeply embedded in the system, e.g., not a shore span, without transmission distortion. The current subject matter may be configured to mitigate and/or substantially eliminate degradation of the interrogation pulse applied to spans that are not shore spans.

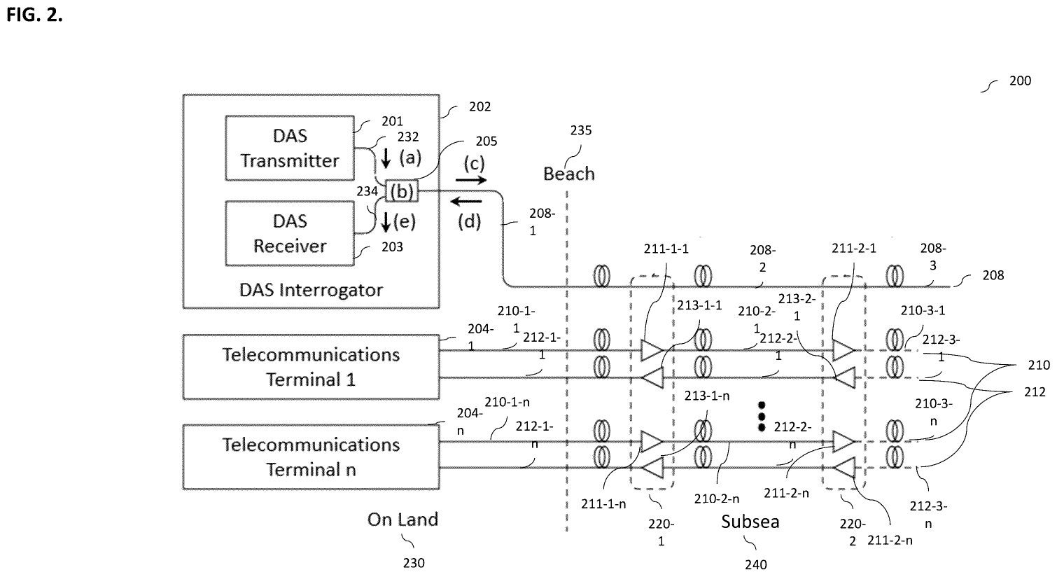

FIG. 2 illustrates another exemplary optical communication system 200 that may implement the distributed acoustic sensing techniques. The system 200 may be used in a subsea environment and/or terrestrial environment. The system 200 may include a DAS interrogator 202 that may include a DAS transmitter 201, a DAS receiver 203 and a circulator (or combiner, and/or any other optical device) 205, one or more terminals (e.g., telecommunications) 204-1 to 204-n, one or more optical paths 208, 210, and 212 (e.g., 208-1 to 208-n, 210-1-1 to 210-1-n, . . . 210-n−1 to 210-n-n (only three paths are shown in FIG. 2), 212-1-1 to 212-1-n, . . . 212-n−1 to 212-n-n (only three of each are shown in FIG. 2)), and one or more repeaters 220-1 to 220-m (only two of each are shown in FIG. 2).

The DAS interrogator 202 may be disposed on land 230 and may be communicatively coupled to the optical path(s) 208. As can be understood, the optical path(s) 208 may include one or more optical path portions 208-1 to 208-n and/or may be a single continuous optical path 208. The DAS transmitter 201 and/or the DAS receiver 203 may be communicatively coupled to the optical path(s) 208. At least a portion of the optical path(s) 208 may be disposed on land 230 and at least another portion of the optical path(s) 208 may be disposed subsea 240 (separated by a beach 235).

The optical path(s) 208 may also be referred to as a DAS optical fiber path. Each terminal 204 may be communicatively coupled to respective optical paths 210 and 212. As can be understood, each of the optical path(s) 210 and 212 may include one or more respective optical path portions 210-1 to 210-n and 212-1 to 212-n (e.g., optical path 210-1 may include optical path portions 210-1-1, . . . , 210-1-n, optical path 210-n may include optical path portions 210-n−1, . . . 210-n-n, etc.) and/or may be single continuous respective optical paths 210 and 212. Each terminal 204 (i.e., 204-1 to 204-n) may also be disposed on land 230 and may be communicatively coupled to a pair of optical paths 210, 212. Optical paths 210 and 212 may also be referred to as telecommunications fiber paths.

Further, each optical path 210 may be referred to as a transmitting and/or outbound optical path, which may be configured to transmit one or more signals (e.g., optical and/or any other signals) from the respective terminal 204. Likewise, each optical path 212 may be referred to as a receiving and/or inbound optical path, which may be configured to receive one or more signals (e.g., optical and/or any other signals) by the respective terminal 204. Each terminal 204 may be communicatively coupled to a pair of optical paths 210, 212. For example, terminal 204-1 may be communicatively coupled to the optical path pair 210-1 (which may include portions 210-1-1, . . . 210-1-3, . . . ) and 212-1 (which may include portions 212-1-1, . . . 212-1-3, . . . ).

As shown in FIG. 2, one or more repeaters 220-1 to 220-m may be positioned across the optical paths 208, 210, and 212. The repeaters 220 may be positioned across optical paths at various points on the paths in the subsea portion 240. As can be understood, the repeaters 220 may also be positioned across optical paths 208-212 at various points on the paths on land 230 (which may or may not include the beach 235). Each repeater 220 may include one or more respective transmitting amplifiers 211 and one or more receiving amplifiers 213 positioned on respective optical paths 208 and 210. For example, repeater 220-1 may include one or more transmitting amplifiers associated with respective terminals 204, e.g., a transmitting amplifier 211-1-1 positioned on optical path 210-1 associated with terminal 204-1, . . . , a transmitting amplifier 211-1-n positioned on optical path 210-n associated with terminal 204-n. The repeater 220-1 may also include one or more receiving amplifiers associated with respective terminals 204, e.g., a receiving amplifier 213-1-1 positioned on optical path 212-1 associated with terminal 204-1, . . . , a receiving amplifier 213-1-n positioned on optical path 212-n associated with terminal 204-n. The amplifiers 211, 213 may serve to amplify transmitting and/or receiving signals, respectively. The amplifiers 211, 213 may be the same or different across all repeaters.

The repeaters 220 may be positioned on optical paths 208, 210, 212 at any desired locations. For example, the repeaters 220 may be equally spaced away from each other in the subsea portion of the optical paths. They may be positioned at a predetermined distance away from each other and/or from respective terminals 204. It should be noted that while terminals 204 are shown to be on one side in FIG. 2, as can be understood, one or more terminals 204 may be communicatively coupled to one or more other terminals 204 using optical paths 208, 210, 212. Moreover, the repeaters 220 may include any other electrical, electronic, optical and/or any other components that may be needed for signal transmission between terminals 204. The repeaters 220 may include a protective housing that may encompass and protect the integrity of amplifiers 211, 213 and/or any other components of repeaters 220. The repeaters 220 may be secured to a seafloor (e.g., anchored) in the subsea 240, buried in the seafloor, floating above seafloor, and/or disposed in any other desired fashion.

As stated above, the system 200 and/or any portion thereof may be configured as a terrestrial system and hence, one or more of its components may be disposed on land. Alternatively, or in addition, some portions of the system 200 (e.g., repeater 220-1) may be disposed on land 230, while other portions of the system 200 (e.g., repeater 220-2) may be disposed subsea 240.

In operation, the DAS interrogator 202 may be communicatively coupled (e.g., directly connected) to a sensing span for monitoring and/or determining whether there are any interruptions, interventions, interferences, breaks, and/or other disruptions to the optical paths 210 and/or 212 (and/or path 208). The sensing span may include one or more portions of the optical paths 208, 210, 212. For example, the sensing span may include at least one or more optical path portions 208-2, 210-2-1, 212-2-1, 212-2-n, 212-2-n that may be disposed between the repeater 220-1 and repeater 220-2. Alternatively, or in addition, the sensing span may include other optical path portions and/or any combination of optical path portions. Further, the interrogator 202 may be configured to monitor only transmitting optical paths (e.g., paths 210) and/or receiving optical paths (e.g., paths 212), and/or any combination thereof.

The transmitter 201 and the receiver 203 of the interrogator 202 may be communicatively coupled to the circulator 205. The circulator 205 may be disposed within the interrogator 202 and/or may be a separately positioned optical device. The transmitter 201 may be communicatively coupled to the circulator 205 using a communication path (e.g., fiber optical path) 232. The receiver 203 may be communicatively coupled to the circulator 205 using a communication path (e.g., fiber optical path) 234. The circulator 205 may receive signals (e.g., optical and/or any other type) from the transmitter 201 via path 232 in a direction (a) for transmission, via the optical path 208-1, toward the repeater 220-1 in a direction (c). Further, the circulator 205 may receive signals (e.g., optical and/or any other type) from the repeater 220-1 via the optical path 208-1 in a direction (d) for transmission to the receiver 203 via the path 234 in a direction (e). The circulator may enable a single fiber bidirectional connection between the transmitter 201 in the direction (c) and the receiver 203 in the direction (d)

To monitor the sensing span, the transmitter 201 of the interrogator 202 may be configured to generate an optical interrogation pulse and transmit it via path 232 to the circulator 205. The interrogation pulse may be transmitted from a common port of the circulator 205, and may be transmitted travels via path 208-1 to the sensing span. The sensing span may backscatter the interrogation pulse along a portion and/or entire length of the sensing span. In existing systems, the sensing span distance may be limited to approximately 50 to 150 km, even though the length of the optical path that may need to be monitored can be longer. The backscattered signal may be transmitted back to the receiver 203 via the path 208-1 in the direction (d). This backscattered signal may be transmitted through the circulator 205 and then via path 234 in the direction (e) to the receiver 203. The receiver 203 and/or any other processing hardware and/or software disposed within the receiver 203 and/or communicatively coupled to the receiver 203 may execute analysis of data associated with any perturbations of the backscattered signal to determine whether or not an interference, interruption, etc. of any communication paths may have occurred. Moreover, as can be understood, one or more of the transmitter 201, the receiver 203, and/or the circulator 205 may be part of the same hardware/software component.

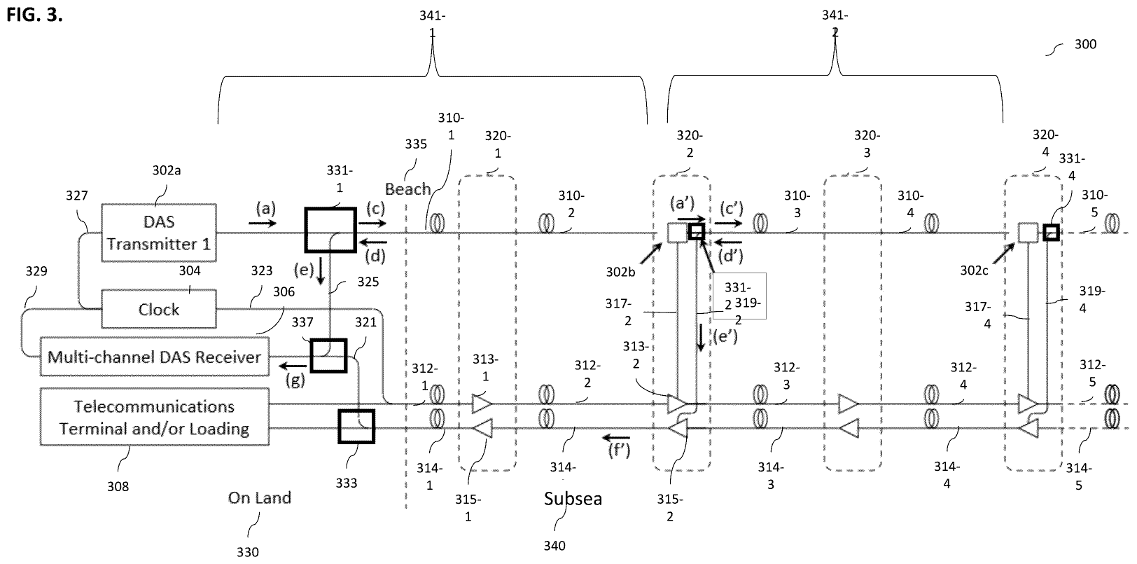

FIG. 3 illustrates an exemplary optical communication system 300 using distributed acoustic sensing, according to some implementations of the current subject matter. Similar to systems 100 and 200, the system 300 may be used in a subsea environment and/or terrestrial environment. In particular, the system 300 may be used in DAS environments for monitoring a span and/or a section of one or more optical paths that might not be directly communicatively coupled to a DAS interrogator (as opposed to system 200 where monitored spans are directly communicatively coupled to the interrogator 202). It should be noted that the term path may refer to any type of communicative coupling and/or connection and may encompass, but is not limited to, an optical coupling and/or connection, electrical coupling and/or connection, electro-optical coupling and/or connection, electro-mechanical coupling and/or connection, electro-optical-mechanical coupling and/or connection, and/or any other type of coupling and/or connection that is capable of transmitting and/or receiving any type of signal.

The system 300 may include one or more DAS transmitters 302 (a, b, c . . . ) (only three are shown in FIG. 3 for illustrative purposes), one or more clocks 304, a DAS receiver 306 (e.g., a multi-channel DAS receiver) and/or one or more DAS receivers, a terminal 308 (e.g., a telecommunications terminal and/or a loading terminal) and/or one or more terminals 308, one or more optical or DAS fiber paths 310 (e.g., 310-1, 310-2, 310-3, 310-4, 310-5, etc.), one or more optical transmitting paths 312 (e.g., 312-1, 312-2, 312-3, 312-4, 312-5, etc.), one or more optical receiving paths 314 (e.g., 314-1, 314-2, 314-3, 314-4, 314-5, etc.), and one or more repeaters 320 (e.g., 320-1, 320-2, 320-3, 320-4, etc.) positioned across paths 310, 312, and 314. As can be understood, the designation of receiving and/or transmitting is used for illustrative purposes only as the optical paths 312, 314 may be communicatively coupled between two or more terminals 308 (one terminal 308 is shown for illustrative purposes, however, another terminal may be communicatively coupled to an opposite end of the paths 312, 314). Moreover, the system 300 may include more than one path 312 and/or more than one path 314 as well as more than one or more receiver 306 and/or more than one terminal 308.

In some implementations, the transmitter 302a, clock 304, receiver 306, and terminal 308 may be disposed on land 330 and may be communicatively coupled to the respective optical path(s). In particular, the transmitter 302a may be communicatively coupled to the optical path 310-1 communicatively coupling the transmitter 302a and the repeater 320-1. The repeater 320-1 may be communicatively coupled to the repeater 310-2 using optical path 310-2, the latter may terminate at the repeater 310-2. The transmitter 302a may also be communicatively coupled to the clock 304 using a path 327. The transmitter 302a may be configured to transmit one or more optical signals (and/or any other signals) using optical path 310-1 in a direction (a).

The receiver 306 may be a multi-channel receiver that may be configured to receive signals on one or more channels and/or from one or more transmitters (e.g., similar to transmitters 302a, 302b, etc.). The receiver 306 may be communicatively coupled to the receiving path 314-1 via an optical path 321. The receiving path 314-1 may be configured to communicatively couple the receiver 306 and the repeater 320-1. In addition to the communicative coupling using paths 310, the repeaters 320 may be communicatively coupled using transmitting path portions 312 and receiving path portions 314 (e.g., repeater 320-1 and repeater 320-2 may be communicatively coupled using transmitting path portion 312-2 and receiving path portion 314-2, etc.). One or more optical signals (and/or any other signals) may be transmitted on the receiving path 314-1 in a direction (g) toward the receiver 306. Moreover, one or more optical signals (and/or any other signals) may be transmitted to the receiver 306 from the optical path 310-1 via a path 325 in a direction (e). Additionally, the receiver 306 may be communicatively coupled to the clock 304.

The terminal 308 may be communicatively coupled to the transmitting path 312-1 and the receiving path 314-1. The transmitting and receiving paths 312, 314 (which may include a plurality of respective transmitting path portions 312-1, 312-2, etc. and receiving path portions 314-1, 314-2, etc.) may include one or more optical path portions shown in FIG. 3 and/or may be a single respective continuous optical paths 312, 314. At least a portion of the optical path(s) 312, 314 may be disposed on land 330 and at least another portion of the optical path(s) 312, 314 may be disposed subsea 340 (separated by a beach 335). One or more repeaters 320-1, 320-2, etc. may be communicatively coupled across the optical paths 312, 314. Further, while FIG. 3 illustrates only a single terminal 308, the optical paths 312, 314 may be configured to provide connections between two or more terminals 308.

Similar to FIG. 2, the optical path(s) 310 may also be referred to as a DAS optical fiber path. Optical paths 312 and 314 may also be referred to as telecommunications fiber optical paths.

As shown in FIG. 3 and discussed above, one or more repeaters 320-1, 320-2, etc. may be positioned across the optical paths and/or one or more portions thereof 310, 312, and 314. The repeaters 320 may be positioned across optical paths at various points on the paths in the subsea 340. As can be understood, the repeaters 320 may also be positioned across optical paths and/or portions thereof 310-312 at various points on the paths on land 330 (which may or may not include the beach 335). Each repeater 320 may include one or more respective transmitting amplifiers 313 and one or more receiving amplifiers 315. The transmitting amplifiers 313 may be positioned on the transmitting path(s) 312. The receiving amplifiers 315 may be positioned on the receiving path(s) 314. For example, repeater 320-1 may include one or more transmitting amplifiers 313-1 and one or more receiving amplifiers 315-1. The amplifiers 313 and 315 may serve to amplify transmitting and/or receiving signals, respectively. The amplifiers 313, 315 may be same or different across all repeaters 320.

The repeaters 320 may be positioned on the optical paths 310, 312, 314 at any desired locations. The locations may be determined based on a length of a span that is desired to be monitored for disturbances, disruptions, etc. Alternatively, or in addition, the repeaters 320 may be equally spaced away from each other in the subsea portion of the optical paths, positioned a predetermined distance away from each other and/or from respective terminals 308, etc. Similar to repeaters 220 shown in FIG. 2, the repeaters 320 may include any electrical, electronic, optical and/or any other components and/or equipment that may be needed for signal transmission between terminals 308, as well as a protective housing enclosing amplifiers 313, 315 and/or any other repeater components. The repeaters 320 may be secured to a seafloor (e.g., anchored) in the subsea 340, buried in the seafloor, floating above seafloor, and/or disposed in any other desired fashion.

In some implementations, one or more of the repeaters 320 may be configured to have a different structure (e.g., include components not present in other repeaters) and/or function (e.g., perform functions that may be different from other repeaters). For example, repeater 320-2, in addition to the transmitting amplifier 313-2 and receiving amplifier 315-2, may be configured to include a DAS transmitter 302b. The transmitter 302b may be communicatively coupled to the transmitting amplifier 313-2 using a path 317-2. Additionally, the transmitter 302b may be communicatively coupled to the optical path (e.g., DAS fiber optical path) 310-3 communicatively coupling the repeater 320-2 to repeater 320-3.

As shown in FIG. 3, the optical path 310-2 may be configured to terminate at the repeater 320-2 without being communicatively coupled to the transmitter 302b. Such optical path termination may be configured to allow the transmitter 302a to monitor and determine whether there are any interferences, interruptions, etc. on the optical paths up to repeater 320-2. As will be discussed in further detail below, by being connected to the transmitting and receiving optical paths 312 and 314 using connections 317-2 and 319-2, the transmitter 302b may be configured to provide further connectivity between repeaters and, thus, perform monitoring of a next sensing span and/or portions of optical paths that communicatively couple repeater 320-2 to the next similar repeater, e.g., repeater 320-4, but might not be directly connected to the transmitter 302a. As shown in FIG. 3, the repeater 320-4 may include next transmitter 302c, which may have similar connections within the repeater 320-4 as the transmitter 302b within the repeater 320-2. As can be understood, one or more repeaters similar to repeaters 320-2, 320-4 may be disposed along optical paths 310, 312, 314 for monitoring specific sections of optical paths. Such repeaters may be alternated with repeaters that are similar to repeaters 320-1 and 320-3, which may be configured to provide standard repeater functionalities of signal amplification and might not be configured to perform the same functionalities as repeaters 320-2, 320-4, etc. Alternatively, or in addition, one or more of the repeaters (e.g., “alternating repeaters”) 320-1, 320-3, etc. may be optional and/or may be omitted and/or may be inactive (e.g., not providing any amplification functions, etc.). Any pattern of repeaters 320 may be formed and may, for example, depend on a length of optical path to be monitored, quality of monitoring signals desired, one or more purposes for performing the monitoring, etc. By way of a non-limiting example, a single repeater (and/or any number of and/or any arrangement of) may be positioned in the optical path and may be configured to perform one or more of the functionalities of any one and/or some and/or all of the repeaters 320, as discussed herein.

In some implementations, the system 300 may be configured to perform monitoring of all or some portions of the optical path(s) using the transmitter-equipped repeaters (e.g., repeaters 320-2, 320-4, etc.). Alternatively, or in addition, the system 300 may be configured to perform monitoring of a portion of the optical paths (e.g., up to a predetermined location, such as, a middle, of one or more optical paths). In the latter scenario, components similar to the transmitter 302a, clock 304, receiver 306, terminal(s) 308 may be communicatively coupled to the respective optical path to perform monitoring of the optical path from another end.

In some example implementations, similar to the system 200, the system 300 and/or any portion thereof may be configured as a terrestrial system and hence, one or more of its components may be disposed on land. Further, one or more portions of the system 300 (e.g., repeater 320-1) may be disposed on land 330, while one or more other portions of the system 300 (e.g., repeater 320-2) may be disposed subsea 340.

In some implementations, in operation, to perform monitoring of a sensing span (e.g., sensing span 341-1) encompassing one or more optical paths 310, 312, and/or 314 and/or portions thereof, the transmitter 302a may be configured to generate an interrogation pulse that may be transmitted in a direction (a) on the optical path 310-1, as shown in FIG. 3. The interrogation pulse may be configured to be transmitted to an optical device 331-1 (e.g., a circulator, a coupler, a combiner, and/or any other type of optical device, and/or any combination thereof). The pulse may then be transmitted (after exiting the common port of the optical device 331-1) on the path 310-1 toward the repeater 320-1 in a direction (c) to the sensing span 341-1, e.g., a section of optical path that may be desired to be monitored. As shown in FIG. 3, the sensing span 341-1 may encompass optical path(s) between the optical device 331-1 and the repeater 320-2, at which the DAS fiber 310-2 terminates. Likewise, another sensing span (e.g., sensing span 341-2) may encompass optical path(s) between the repeater 320-2 (and/or its optical device 331-2 (and/or a circulator, a coupler, a combiner, etc.)) and the repeater 320-4.

In response to receiving the interrogation pulse from the transmitter 302a, the sensing span 341-1 may be configured to backscatter the interrogation pulse all along the length of the sensing span 341-1. The backscattered signal may be configured to be transmit back towards the receiver 306 in a direction (d). In particular, the backscattered signal may be transmitted through optical device 331-1 and then via path 325 in a direction (e) to an optical device 337 (e.g., a circulator, a coupler, a combiner, and/or any other optical device, and/or any combination thereof). The output of the optical device 337 may be configured to be transmitted to the receiver 306 in a direction (g). The receiver 306 may be configured to execute analysis of the received signal to determine whether there are any interferences, interruptions, etc. in the optical path based on perturbations in the backscattered signal.

In some implementations, to monitor the sensing span 341-2, one or more repeaters 320, such as, for example, repeater 320-2, positioned in the subsea 340, may be configured to include components that are similar to those discussed above. In particular, in addition to amplifiers and the transmitter 302b, the repeater 320-2 may include an optical device 331-2 that may be similar to the optical device 331-1. The optical device 331-2 may be communicatively coupled to the transmitter 302b as well as a receiving amplifier 315-2 via path 319-2.

To monitor sensing span 341-2, the transmitter 302b, in the repeater 320-2, may be configured to execute functions that are similar to the functions executed by the transmitter 302a positioned on land 330. In particular, the transmitter 302b may be configured to generate an interrogation pulse that may be transmitted in a direction (a′) on the optical path 310-3 (which communicatively couples the repeater 320-2 and repeater 320-3). The interrogation pulse may be configured to be transmitted to the optical device 331-2 and may then be transmitted (after exiting a common port of the optical device 331-2) on the path 310-3 toward the repeater 320-3 in a direction (c′) to the sensing span 341-2. As shown in FIG. 3, the sensing span 341-2 may encompass optical path(s) between the optical device 331-2 and the repeater 320-4, at which the DAS fiber 310-4 terminates.

Responding to the interrogation pulse received from the transmitter 302b, the sensing span 341-2 may backscatter the interrogation pulse all along the length of the sensing span 341-2. The backscattered signal may be configured to be transmitted in a direction (d′) towards the receiver 306. However, since there is no connection between the optical path portion 310-2 and the repeater 320-2, the backscattered signal may be transmitted through optical device 331-2 and then via path 319-2 in a direction (e′) to the receiving amplifier 315-2. The amplifier 315-2 may be configured to amplify the backscattered signal for transmission along the receiving paths 314-2 and 314-1. The amplified backscattered signal may be combined and/or added to the signal traffic being transmitted on the receiving paths 314-2 and 314-1 to the receiver 306 in a direction (f) via an optical device 333 (e.g., a circulator, a coupler, a combiner, and/or any other optical device, and/or any combination thereof). The combined signal may include any telecommunication traffic along with the backscattered signal and/or any clock synchronization signals.

The output of the optical device 333 may be configured to be transmitted to the receiver 306 in a direction (g). The combined signal (e.g., one or more backscattered signals (e.g., from the repeater 320-2 and/or other like repeaters) and any other signals) may be received at an optical device 333 that may be positioned on the receiving path 314-1. The optical device 333 may be a combiner, a circulator, a coupler, and/or any other optical device and/or any combination thereof. The optical device 333 may be configured to separate and/or extract the backscattered signal received from the repeater 320-2 (and/or any other repeater) and transmit it, via path 321, to the optical device 337, which, in turn, transmits it in the direction (g) to the receiver 306.

The receiver 306 may be configured to execute analysis of the backscattered signal from the repeater 320-2 (and/or any other repeater) to determine whether there are any interferences, interruptions, etc. in the sensing span 341-2 (and/or any other sensing spans). The remaining signals associated with the receiving optical path may be transmitted to the terminal 308. As shown in FIG. 3, the optical devices 331, 333, 337 may be positioned on land 340, however, as can be understood, any and/or all of these devices may be positioned on land 340, at the beach 335, and/or subsea 340.

In some implementations, the clock 304 of the system 300 may be configured to ensure that the transmitted interrogation pulses and backscattered signals, and thus, the transmitters 302a, 302b, etc. and the receiver 306 are synchronized. The clock 304 may be communicatively coupled to the transmitter 302a and the receiver 306. The clock 304 may be configured to generate a synchronization signal that may be transmitted via the path 323 to transmitting path(s) 312 and through the land and subsea portions of the system 300. The synchronization signal may be detected by the repeater 320-2 (and/or other repeater 320-4, etc.) and may be used to trigger the transmitter 320b to generate the above interrogation pulse. Using this synchronization signal, all transmitters 302 and the receiver 306 may know when a particular interrogation pulse was transmitted, which may allow the receiver 306 to determine which received backscattered signal is associated with a specific interrogation pulse, and hence, a particular sensing span 341.

Alternatively, or in addition, one or more repeaters 320 (e.g., repeater 320-2) may be configured to include its own clock component that may be configured to generate synchronization signals. The clock components within all repeaters that have them and the clock 304 may be synchronized to ensure accurate timing of interrogation pulses and backscattered signals. As the backscattered signals received from the optical paths 310 arrive at different times, the receiver 306 may be configured to correlate generated interrogation pulses and backscattered signals based on the time of generation of interrogation pulses and synchronization data associated with each clock component.

In some implementations, each transmitter 302 may be configured to operate at same and/or different wavelengths (the latter being common to wavelength division multiplexing (WDM) systems). This may allow the receiver 306 to differentiate between the received signals. The optical path(s) carrying the synchronizing clock signal and the backscattered signals may also transmit any telecommunication traffic signals, loading signals, and/or any other type of signals.

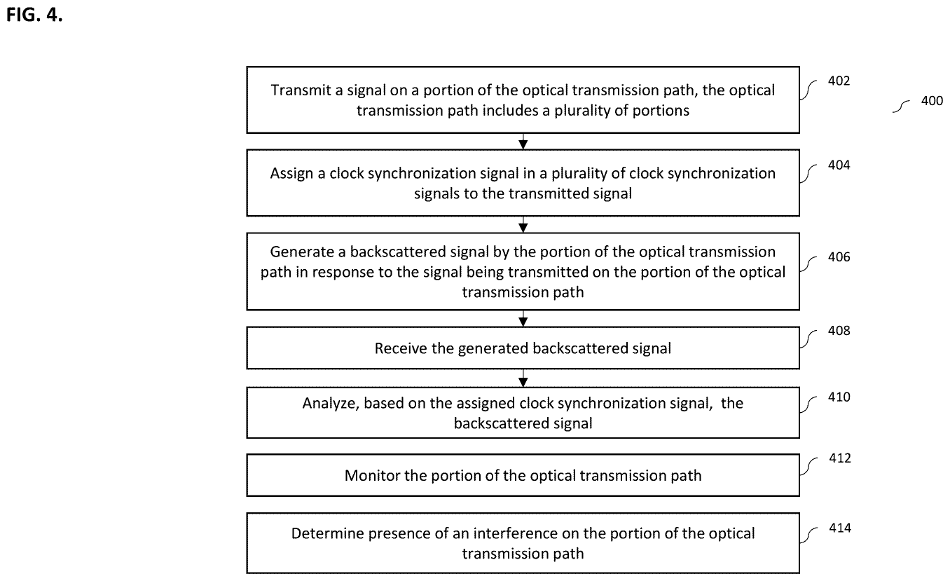

FIG. 4 illustrates an example process 400 for monitoring an optical transmission path in an optical transmission system, according to some implementations of the current subject matter. The method 400 may be performed by the system 300 shown in FIG. 3. In particular, components, such as the transmitters 302, receiver 306, repeaters 320 (e.g., repeaters 320-2, 320-4, etc.), the clock 304 along with various optical devices (e.g., combiners, circulators, couplers, etc.) 331, 333, and/or 337, as well as any other devices, including various processors.

At 402, one of the transmitters (e.g., 302a, 302b, etc.) may be configured to transmit a signal (e.g., an interrogation signal) on a portion (e.g., 310-1, 310-3, etc.) of the optical transmission path 310, e.g., a DAS fiber optical transmission path. As shown in FIG. 3, the optical transmission path may include a plurality of portions 310-1, 310-2, 310-3, etc. Each portion 310 may include a termination point (e.g., path portion 310-1 and 310-2 have a termination point at repeater 320-2), which may be associated with a particular sensing span (e.g., 340-1) that is being monitored for any interruptions, interferences, faults, etc.

At 404, the clock 304 may be configured to assign a clock synchronization signal (e.g., in a plurality of clock synchronization signals) to the transmitted signal. Once the clock synchronization signal is assigned, the receiver 306 may be informed that a signal has been transmitted by the transmitter 302. The assignment of clock synchronization signals may be performed simultaneously with transmission of interrogation signals.

At 406, the optical path portion, e.g., the sensing span 340-1 may be configured to generate a backscattered signal in response to the transmitter interrogation signal. The backscattered signal may be generated along the entire sensing span. The backscattered signal may be received by the receiver 306. Depending on the positioning of the transmitter 302 that generated the interrogation signal and the sensing span 340 being monitored, the backscattered signal may be transmitted via one or more of the repeaters 320 (e.g., 320-2) and one or more of the optical devices 333, 337.

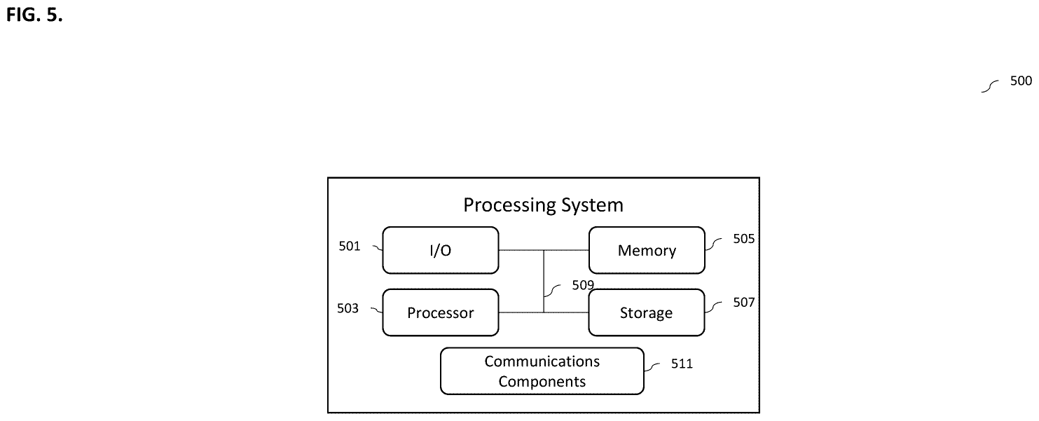

At 408, the receiver 306 may be configured to receive the backscattered signal and analyze it, at 410. The analysis may be performed using one or more processing systems of the receiver 306. An example of such a processing system is illustrated in FIG. 5.

As shown in FIG. 5, the processing system 500 may include an input/output (I/O) device 501, a processor 503, a memory 505, a storage 507, and one or more communication components 511. Each of the components 501-507 may be interconnected using a system bus 509. The processor 503 may be configured to process instructions for execution within system 500. In some implementations, the processor 503 may be a single-threaded processor. Alternatively, or in addition, the processor 503 may be a multi-threaded processor. The processor 503 may be further configured to process instructions stored in the memory 505 and/or in the storage 507, including, but not limited to, receiving and/or sending information through the I/O device 501. The memory 505 may store information within the system 500. In some implementations, the memory 505 may be a computer-readable medium. Alternatively, or in addition, the memory 505 may be a volatile memory unit. In yet some implementations, the memory 505 may be a non-volatile memory unit. The storage 507 may be capable of providing mass storage for the system 500. In some implementations, the storage 507 may be a computer-readable medium. Alternatively, or in addition, the storage 507 may be a floppy disk device, a hard disk device, an optical disk device, a tape device, non-volatile solid state memory, or any other type of storage device. The I/O device 501 may provide input/output operations for the system 500. In some implementations, the I/O device 501 may include a keyboard and/or pointing device. Alternatively, or in addition, the I/O device 501 may include a display unit for displaying graphical user interfaces.

In some example implementations, one or more components of the system 500 may include any combination of hardware and/or software. In some implementations, one or more components of the system 500 may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example implementations, one or more components of the system 500 may be disposed on a single computing device and/or may be part of a single communications network. Alternatively, or in addition to, such services may be separately located from one another.

In some implementations, the system 500's one or more components may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system 500 also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 500 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. One or more components of the system 500 may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some example implementations, one or more components of the system 500 may execute one or more applications, such as software applications, that enable, for example, network communications with one or more components of system 500 and transmit and/or receive data.

One or more components of the system 500 may include and/or be in communication with one or more servers via one or more networks and may operate as a respective front-end to back-end pair with one or more servers. One or more components of the system 500 may transmit, for example, from a mobile device application (e.g., executing on one or more user devices, components, etc.), one or more requests to one or more servers. The requests may be associated with retrieving data from servers. The servers may receive the requests from the components of the system 500. Based on the requests, servers may be configured to retrieve the requested data from one or more databases. Based on receipt of the requested data from the databases, the servers may be configured to transmit the received data to one or more components of the system 500, where the received data may be responsive to one or more requests.

The system 500 may include and/or be communicatively coupled to one or more networks. In some implementations, networks may be one or more of a wireless network, a wired network or any combination of wireless network and wired network and may be configured to connect the components of the system 500 and/or the components of the system 500 to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, and home networks.

The system 500 may include and/or be communicatively coupled to one or more servers, which may include one or more processors that maybe coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system 500.

Referring back to FIG. 4, at 412, the system 300 may be configured to perform monitoring of the DAS optical path to determine whether any interference, interruption, fault, etc. may be presented on the DAS optical path, at 414. The determination of such interference may be determined using processing system 500, for example.

The various elements of the components as previously described with reference to FIGS. 1-3 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores”, may be stored on a tangible, machine readable medium and supplied to various customers or manufacturing facilities to load into the fabrication machines that make the logic or processor. Some implementations may be implemented, for example, using a machine-readable medium or article which may store an instruction or a set of instructions that, if executed by a machine, may cause the machine to perform a method and/or operations in accordance with the implementations. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writable or rewritable media, digital or analog media, hard disk, floppy disk, Compact Disk Read Only Memory (CD-ROM), Compact Disk Recordable (CD-R), Compact Disk Rewritable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in implementations.

At least one computer-readable storage medium may include instructions that, when executed, cause a system to perform any of the computer-implemented methods described herein.

Some implementations may be described using the expression “one implementation” or “an implementation” along with their derivatives. These terms mean that a particular feature, structure, or characteristic described in connection with the implementation is included in at least one implementation. The appearances of the phrase “in one implementation” in various places in the specification are not necessarily all referring to the same implementation. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single implementation for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separate implementation. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example implementations has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed:

1. A method for monitoring an optical transmission path in an optical transmission system, the method comprising:
transmitting a signal on a portion of the optical transmission path, the optical transmission path includes a plurality of portions;
assigning a clock synchronization signal in a plurality of clock synchronization signals to the transmitted signal;
receiving a backscattered signal, the backscattered signal being generated by the portion of the optical transmission path in response to the signal being transmitted on the portion of the optical transmission path; and
monitoring, based on the assigned clock synchronization signal, the portion of the optical transmission path by analyzing the backscattered signal to determine a presence of an interference on the portion of the optical transmission path.

2. The method according to claim 1, wherein the optical transmission path is a distributed acoustic sensing optical transmission path.

3. The method according to claim 2, wherein the optical transmission system includes a plurality of terminals communicatively coupled to at least one transmitting path for transmitting and at least one receiving path for receiving one or more signals between at least two terminals in the plurality of terminals.

4. The method according to claim 3, wherein the transmitting the signal includes transmitting the signal from a transmitting optical device communicatively coupled to the portion of the optical transmission path.

5. The method according to claim 3, wherein a plurality of transmitting optical devices are communicatively coupled to optical transmission path, each transmitting optical device in the plurality of transmitting optical devices being communicatively coupled to a respective portion in the plurality of portions of the optical transmission path without being communicatively coupled to another portion in the plurality of portions of the optical transmission path.

6. The method according to claim 5, wherein a receiving optical device is communicatively coupled to the optical transmission path and is configured to receive a plurality of backscattered signals generated by each portion in the plurality of portions of the optical transmission path in response to a respective signal transmitted by the corresponding transmitting optical device in the plurality of transmitting optical devices.

7. The method according to claim 6, wherein at least one optical repeater device is communicatively coupled to the optical transmitting path, the at least one optical repeater device includes at least one transmitting optical device in the plurality of optical transmitting devices and being associated with at least one portion in the plurality of portions of the optical transmission path.

8. The method according to claim 7, wherein the at least one optical repeater device includes at least one receiving amplifier and at least one transmitting amplifier, the at least one receiving amplifier amplifies a signal transmitted on the at least one receiving path, and the at least one transmitting amplifier amplifies a signal transmitted on the at least one transmitting path.

9. The method according to claim 8, wherein the at least one receiving amplifier amplifies at least one backscattered signal generated by at least one portion of the optical transmitting path communicatively coupled to the at least one optical repeater device in response to at least one signal transmitted by the at least one transmitting optical device of the at least one optical repeater device.

10. The method according to claim 9, wherein the at least one optical repeater device being communicatively coupled to the at least one receiving optical device.

11. The method according to claim 10, wherein at least one first optical device is communicatively coupled to and between the at least one optical repeater device and the at least one receiving optical device, the at least one receiving optical device being configured to separate the at least one backscattered signal for transmission to the at least one receiving optical device and the at least one signal transmitted on the at least one receiving path for transmission to at least one terminal in the plurality of terminals.

12. The method according to claim 1, wherein the transmitting includes generating the clock synchronization signal simultaneously with transmitting the signal.

13. The method according to claim 12, wherein the receiving the backscattered signal includes associating the backscattered signal with the generated clock synchronization signal based on a time of generation of the clock synchronization signal.

14. The method according to claim 1, wherein the signal is an interrogation signal.

15. The method according to claim 1, wherein each portion in the plurality of portions includes a termination point, wherein at least one of: at least one portion in the plurality of portions of the optical transmission path and at least one termination point is located at at least one of: a land location, a subsea location, and any combination thereof.

16. A system for monitoring an optical transmission path in an optical transmission system, the system comprising:
at least one transmitting optical device configured to transmit a signal on a portion of the optical transmission path, the optical transmission path includes a plurality of portions;
at least one clock configured to assign a clock synchronization signal in a plurality of clock synchronization signals to the transmitted signal;
at least one receiving device configured to receive a backscattered signal, the backscattered signal being generated by the portion of the optical transmission path in response to the signal being transmitted on the portion of the optical transmission path; and
at least one processor configured to monitor, based on the assigned clock synchronization signal, the portion of the optical transmission path by analyzing the backscattered signal to determine a presence of an interference on the portion of the optical transmission path.

17. The system according to claim 16, wherein the optical transmission path is a distributed acoustic sensing optical transmission path.

18. The system according to claim 17, further comprising
a plurality of terminals communicatively coupled to at least one transmitting path for transmitting and at least one receiving path for receiving one or more signals between at least two terminals in the plurality of terminals; and
a plurality of transmitting optical devices communicatively coupled to the optical transmission path, each transmitting optical device in the plurality of transmitting optical devices being communicatively coupled to a respective portion in the plurality of portions of the optical transmission path without being communicatively coupled to another portion in the plurality of portions of the optical transmission path;
wherein the at least one receiving optical device is communicatively coupled to the optical transmission path and is configured to receive a plurality of backscattered signals generated by each portion in the plurality of portions of the optical transmission path in response to a respective signal transmitted by the corresponding transmitting optical device in the plurality of transmitting optical devices.

19. The system according to claim 18, further comprising
at least one optical repeater device communicatively coupled to the optical transmission path and to the at least one receiving optical device, the at least one optical repeater device includes at least one transmitting optical device in the plurality of optical transmitting devices and being associated with at least one portion in the plurality of portions of the optical transmission path;
the at least one optical repeater device includes at least one receiving amplifier and at least one transmitting amplifier, the at least one receiving amplifier amplifies a signal transmitted on the at least one receiving path, and the at least one transmitting amplifier amplifies a signal transmitted on the at least one transmitting path;
the at least one receiving amplifier amplifies at least one backscattered signal generated by at least one portion of the optical transmitting path communicatively coupled to the at least one optical repeater device in response to at least one signal transmitted by the at least one transmitting optical device of the at least one optical repeater device.

20. The system according to claim 19, further comprising at least one first optical device communicatively coupled to and between the at least one optical repeater device and the at least one receiving optical device, the at least one receiving optical device being configured to separate the at least one backscattered signal for transmission to the at least one receiving optical device and the at least one signal transmitted on the at least one receiving path for transmission to at least one terminal in the plurality of terminals;
wherein the at least one receiving optical device associates the backscattered signal with the generated clock synchronization signal based on a time of generation of the clock synchronization signal.
